(19) United States
(12) Patent Application Publication
(10) Pub. No.: US 2005/0123364 A1
(43) Pub. Date: Jun. 9, 2005

(54) Burnishing burr drill

(76) Inventor: Qing Zhou, Shanghai (CN)

Correspondence Address: ARTHUR KING MA, 1030 CORONADO DRIVE, ARCADIA, CA, 91007, US

(21) Appl. No.: 11/037,440

(22) Filed: Jan. 18, 2005

Related U.S. Application Data
(63) Continuation-in-part of application No. 10/384,891, filed on Mar. 10, 2003.

(51) Int. Cl. B23C 5/10

(52) U.S. Cl. 407/53

(57) ABSTRACT

A burnishing Burr drill having more than two large teeth and more than one small tooth formed on each back surface of the large tooth is disclosed. Large teeth is mainly used for cutting and obtaining a high feed speed. As the burnishing drill feed forward, the small teeth will meet a surface of a hole drilled by the large teeth and further finish a wall of the hole.

### RELATED APPLICATIONS

This application is a continuation-in-part application of the U.S. patent application Ser. No. 10/384,891, filed on Mar. 10, 2003, now abandoned, the contents of which are herein incorporated by reference.

### BACKGROUND OF THE PRESENT INVENTION

1. Field of the Present Invention

The invention relates to a burnishing Burr drill, and more particularly, to a Burr drill having a plurality of large teeth each having more than one fine teeth on a back thereof. The burnishing Burr drill of the invention therefore is able to drill a hole with a polished wall while keeping a relatively high feed speed.

2. Description of Related Arts

### SUMMARY OF THE PRESENT INVENTION

Conventional drills usually have a shank and a head integrally formed thereon. The heads have more than one teeth used for cutting. Sizes of the teeth differ from one to another according to various uses thereof. For example, generally large teeth are used to obtain a high feed speed while small teeth are used for refine. Whenever a fine wall of a hole drilled by large teeth is needed, a fine teeth drill must be used to further work on the hole, which takes time and power.

So there are endeavors to find a kind of drill head which is able to both drill a hole at a high feed speed and refine the hole at the same time. The burnishing drill disclosed in U.S. Pat. No. 5,312,208 is such a drill. The drill has a first pair of cutting edges used for getting a high feed speed, and a second and a third pair of cutting edges which is used for refine. However, this drill has three drawbacks. First, the drill only has a pair of cutting edges. This heavily negatively affected a feed speed thereof. In fact, when quantity of cutting edges is reduced as many as two, a high feed speed always cannot be obtained. Secondly, a ratio between a height and width of all cutting edges is too large, which means the cutting edges are too “thin” to have a satisfactory strength. Thirdly, as the second and the third cutting edges are separate and discrete from the first pair of cutting edges, they are especially thin and not able to provide a high product quality.

Therefore, the main object of the invention is to provide a burnishing Burr drill with more than two cutting edges which is able to obtain a high feed speed at the same time. Another object of the invention is to provide a burnishing Burr drill a ratio between a height and width of cutting edges of which is much reduced than conventional art and thus has a higher strength.

Yet another object is to provide a drill a cutting edges thereof do not separate and discrete from main cutting edges thereof therefore are not so thin that do not have enough strength. And burnishing Burr drill is definitely different with normal drills which are normally used for drilling. The burnishing Burr drill of the invention is normally for grinding and polishing.

### BRIEF DESCRIPTION OF THE DRAWINGS

FIG. 1 is a perspective view of a preferred embodiment of the invention.

FIG. 2 is a cross-sectional view of a head of the invention as shown in FIG. 1.

FIG. 3 is a perspective view of another preferred embodiment of the invention.

### DETAILED DESCRIPTION OF THE PREFERRED EMBODIMENT

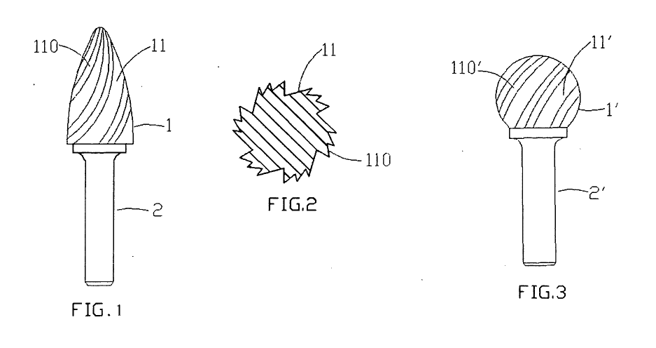

With reference to FIGS. 1 and 2, a burnishing Burr drill of the invention is shown. The burnishing Burr drill has a drill head 1 and a shank 2 connected thereto and longitudinally extends downward. The drill head 1 shown in the Figs. is bullet-head shaped. The drill head 1 has more than two, preferably more than 5, large teeth 11 mainly used for cutting and obtaining most feed speed. Each large teeth 111 has a front surface 12 and a back surface 13. More than one small tooth 131 is formed on the back surface 13 of each large tooth 11. In use, when the drill head 1 works on a workpeice, the large teeth 11 cut the workpeice material first will define a hole in the workpeice. As the burnishing drill feed forward, the small teeth 131 meet a surface of the hole and further finish a wall of the hole.

As shown in FIG. 3, the drill head 1 can be made ball-shaped.

Although the present invention has been described in detail, it should be understood that various changes, combinations, substitutions and alterations can be made hereto without departing from the spirit and scope of the invention as described by the appended claims.

1. A burnishing Burr drill comprising:
a drill head and a shank longitudinally extending downward;
more than two large teeth formed on said drill head and mainly used for cutting a hole, each having a front surface and a back surface; and,
more than one small tooth formed on said back surface of each said large tooth.

2. The burnishing Burr drill as claimed in claim 1, wherein said drill head is bullet-head-shaped.

3. The burnishing Burr drill as claimed in claim 1, wherein said drill dead is ball-shaped.

4. The burnishing Burr drill as claimed in claim 1, wherein said burnishing Burr drill has four large teeth.

5. The burnishing Burr drill as claimed in claim 1, wherein said burnishing Burr drill has five large teeth.

6. The burnishing Burr drill as claimed in claim 1, wherein said burnishing Burr drill has six large teeth.
